(19) United States
(12) Patent Application Publication
(10) Pub. No.: US 2021/0029458 A1
(43) Pub. Date: Jan. 28, 2021

(54) Speaker Device and Mobile Terminal

(71) Applicant: AAC Technologies Pte. Ltd., Singapore City (SG)

(72) Inventors: Xingzhi Huang, Shenzhen (CN); Lin Liu, Shenzhen (CN); Dijiang Tong, Shenzhen (CN); Zhe Zhang, Shenzhen (CN); Jun Wu, Shenzhen (CN); Zhichen Chen, Shenzhen (CN); Zhaoyu Yin, Shenzhen (CN)

(21) Appl. No.: 16/994,701

(22) Filed: Aug. 17, 2020

Related U.S. Application Data
(63) Continuation of application No. PCT/CN2019/097586, filed on Jul. 24, 2019.

(30) Foreign Application Priority Data
Jul. 22, 2019 (CN) 201921155951.0

(51) Int. Cl. H04R 9/02; H04R 1/02; H04R 1/28; H04R 7/02

(52) U.S. Cl. CPC H04R 9/022; H04R 1/025; H04R 2201/02; H04R 1/023; H04R 7/02; H04R 1/2811

(57) ABSTRACT

The present application provides a speaker device having a speaker box, a heat source and a thermally conductive element. The speaker box includes a housing body with a first accommodation space, a speaker unit accommodated in the first accommodation space and a thermally conductive covering plate. The speaker unit comprises a diaphragm partitioning the first accommodation space into a front acoustic cavity and a back cavity, and a through opening. The thermally conductive element connects the speaker box with the heat source for providing improved heat radiation efficiency.

### FIELD OF THE PRESENT DISCLOSURE

The present application relates to the field of electroacoustic transducers and in particular relates to a speaker device and a mobile terminal.

### DESCRIPTION OF RELATED ART

With the advent of the mobile Internet Era, smart mobile devices are increasing. However, undoubtedly, mobile phones are the most common and portable mobile terminal devices in numerous mobile devices. A speaker unit for broadcasting sound is massively used in modern intelligent mobile equipment such as a mobile phone.

A mobile terminal of related technologies comprises a housing, a screen which is arranged on the housing in a covering manner and encircles an accommodation space together with the housing, a heat source which is accommodated in the accommodation space, and a heat radiation copper tube which is at least partially adhered to the heat source; the heat radiation copper tube is arranged in the mobile terminal and is generally adhered to a middle frame of the housing; and the heat source achieves heat radiation through the middle frame.

However, in the related technologies, heat is easily accumulated in the mobile terminal and cannot be radiated out of the mobile terminal, so that the heat can be easily accumulated in the mobile terminal, and a poor heat radiation effect is caused.

Therefore, it is necessary to provide a novel speaker device and a mobile terminal to solve the technical problems.

### SUMMARY OF THE INVENTION

One of the main objects of the invention is to provide a speaker device with improved heat dissipation performance.

Accordingly, the present invention provides a speaker device, comprising:

a speaker box for sounding, including a housing body with a first accommodation space;

a speaker unit accommodated in the first accommodation space, including a diaphragm for partitioning the first accommodation space into a front acoustic cavity and a back cavity;

a through opening penetrating through the housing body;

a heat source spaced from the speaker box;

a thermally conductive covering plate covering the through opening, and encircling the front acoustic cavity together with the diaphragm and the housing body;

a sound channel penetrating through the housing body for communicating the front acoustic cavity with outside for forming a front cavity together with the front acoustic cavity;

a thermally conductive element connected with the speaker box and a heat source; wherein

the thermally conductive element comprises a first end fixed on one side of the thermally conductive covering plate far away from the diaphragm, a second end spaced from the first end and fixed at the heat source, and a connection part for connecting the first end and the second end.

In addition, the housing body comprises an upper cover and a lower cover engaging with the upper cover for forming the first accommodation space together; the through opening is arranged penetrating through the upper cover; the thermally conductive covering plate, the diaphragm and the upper cover encircle the front acoustic cavity together; the sound channel is formed in the upper cover; and the lower cover, the upper cover and the diaphragm encircle the back cavity together.

In addition, an orthographic projection of the thermally conductive covering plate to the diaphragm along a vibration direction of the diaphragm at least partially falls on the diaphragm.

In addition, an orthographic projection of the first end to the thermally conductive covering plate along the vibration direction of the diaphragm completely falls on the thermally conductive covering plate.

In addition, the thermally conductive element and the thermally conductive covering plate are integrally formed.

In addition, the thermally conductive covering plate is any one of a steel piece and a copper piece.

In addition, the thermally conductive element is of a hollow integrally formed structure; and the thermally conductive element is filled with a heat conduction medium.

In addition, the thermally conductive element is of a solid integrally formed structure; and the thermally conductive element is made of a thermally conductive material.

In addition, the heat source is any one of a processor and a battery.

The present invention further provides a mobile terminal, comprising: a housing; a screen engaging with the housing for encircling a second accommodation space together with the housing; a speaker device as described above mounted in the second accommodation space. The housing is provided with a voice outlet penetrating through the housing; the voice outlet is in air communication with the front acoustic cavity through the sound channel so as to radiate heat conducted to the front acoustic cavity by the heat source through the thermally conductive element out of the housing.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric view of a speaker device in accordance with an exemplary embodiment of the present application;

FIG. 2 is a partial exploded view of the speaker device;

FIG. 3 is another partial exploded view of the speaker device;

FIG. 4 is a cross-sectional view of a line A-A along the FIG. 1;

FIG. 5 is an exploded view of a mobile terminal of an embodiment of the present application;

FIG. 6 is a cross-sectional view of the mobile terminal taken along line B-B in FIG. 5;

FIG. 7 is a partially enlarged view of part C in FIG. 6.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

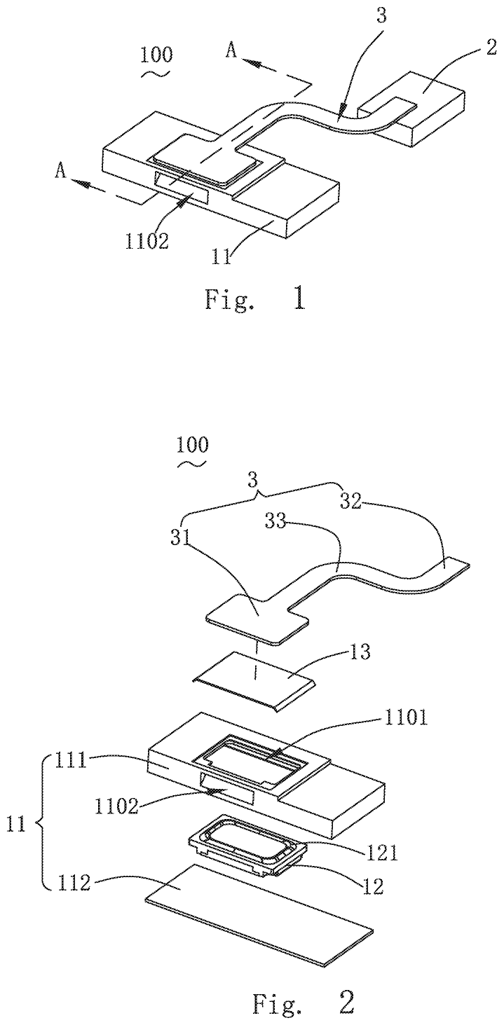

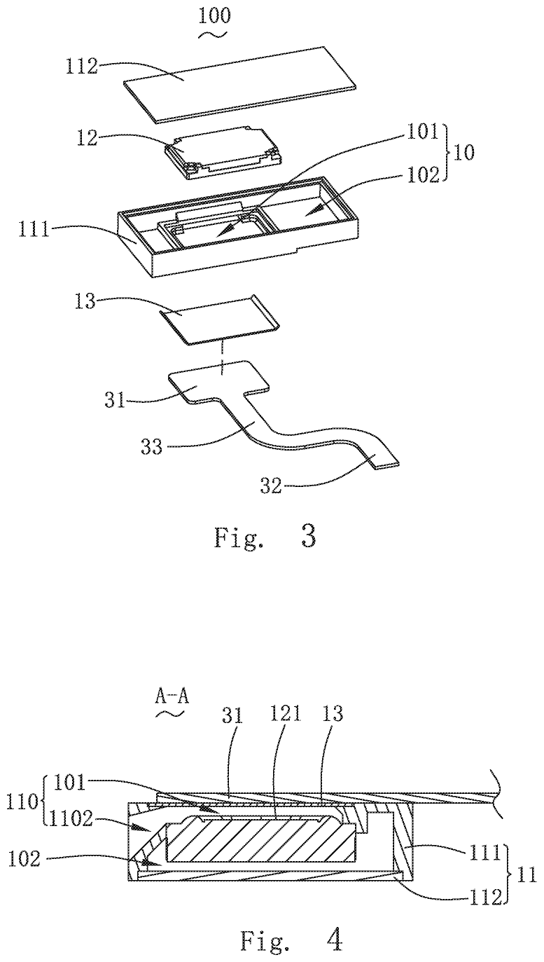

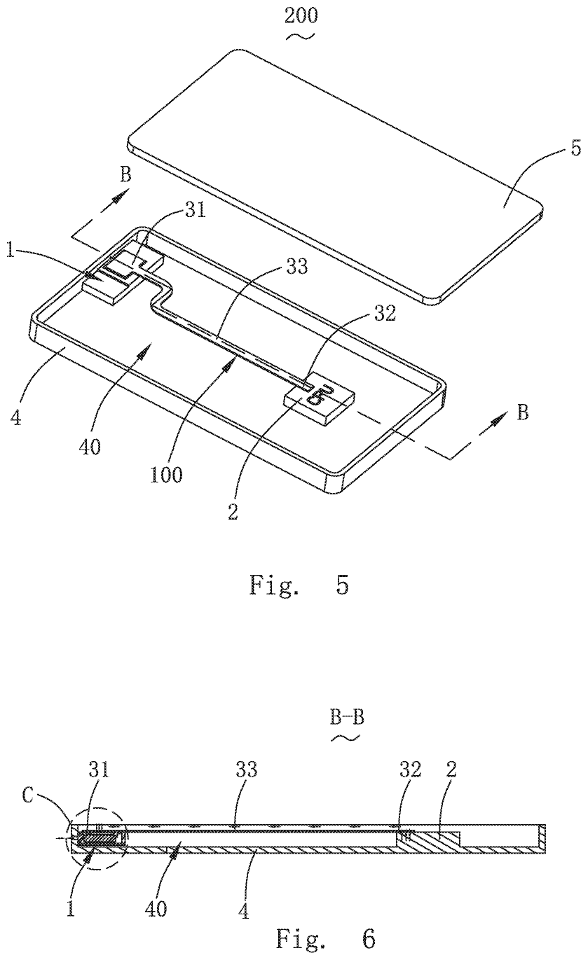

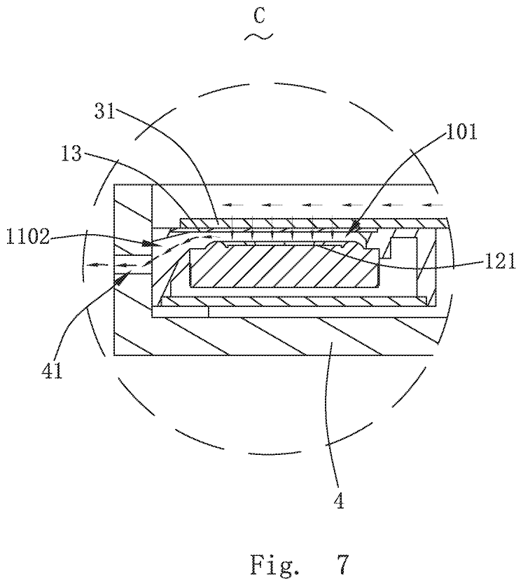

Referring to FIGS. 1-7, the present application provides a speaker device 100 and a mobile terminal 200 with the speaker device 100.

The speaker device 100 provided by the present application comprises a speaker box 1, a heat source 2 and a thermally conductive element 3 which is arranged at an interval with the speaker box 1.

The speaker box 1 comprises a housing body 11, a speaker unit 12 and a thermally conductive covering plate 13.

Specifically, the housing body 11 is provided with a first accommodation space 10 and a through opening 1101 and a sound channel 1102 formed in the first accommodation space 10 in a penetration manner.

The structure form of the housing body 11 is not limited, it can be an integral structure or a split structure; for example, in the embodiment, the housing body 11 is of a split structure which comprises an upper cover 111 and a lower cover 112 which is arranged on the upper cover 111 in a covering manner to form the first accommodation space 10 together. Both the through opening 1101 and the sound channel 1102 are arranged penetrating through the upper cover 111 and are arranged at an interval mutually.

The speaker unit 12 is accommodated in the first accommodation space 10 and comprises a diaphragm 121 for vibration sounding, and diaphragm 121 partitions the first accommodation space 10 into a front acoustic cavity 101 and a back cavity 102.

The thermally conductive covering plate 13 is arranged at the through opening 1101 in a covering manner and encircles the front acoustic cavity 101 with the diaphragm 121 and the housing body 11 together, that is, in the embodiment, the thermally conductive covering plate 13, the diaphragm 121 and the upper cover 111 encircle the front acoustic cavity 101 together; the sound channel 1102 communicates the front acoustic cavity 101 with the outside and forms the front cavity 110 with the front acoustic cavity 101 together so as to form a lateral sounding structure. The lower cover 112, the upper cover 111 and the diaphragm 121 encircle the back cavity 102 to improve the low-frequency acoustic performance of the speaker box 1.

The heat source 2 is capable of generating heat. Specifically, the heat source 2 is an electronic element mounted on the mobile terminal 200, a great deal of heat is generated in the operation process of the heat source 2, and as an optional application mode, the heat source 2 is any one of a processor and a battery. Of course, not limited to this, other heating components such as a screen and a sensor can be also the heat source 2.

The thermally conductive element 3 comprises a first end 31, a second end 32 and a connection part 33.

The first end 31 is arranged on one side of the thermally conductive covering plate 13 far away from the diaphragm 121 in an adhesion manner and is used as a condensation end of the thermally conductive element 3; the second end 32 and the first end 31 are arranged at an interval and are arranged at the heat source 2 in an adhesion manner; and the connection part 33 extends to the second end 32 from the first end 31.

In the structure, the heat generated from the heat source 2 is conducted to the second end 32 and is conducted to the first end 31 through the connection part 33, the heat is conducted to the front acoustic cavity 101 by the first end 31 through the thermally conductive covering plate 13, and the diaphragm 121 vibrates to push air in the front acoustic cavity 101 to communicate with the outside through the sound channel 1102. Specifically, variation of the volume of the front acoustic cavity 101 when the diaphragm 121 vibrates: when the volume of the front acoustic cavity 101 is reduced, the diaphragm 121 exhausts a part of air in the front acoustic cavity 101 outside through the sound channel 1102; when the volume of the front acoustic cavity 101 is increased, the diaphragm 121 sucks the air outside into the front acoustic cavity 101 through the sound channel 1102; and in the process, the air in the front acoustic cavity 101 is in convection with the air outside. Along with vibration of the diaphragm 121, heat in the front acoustic cavity 101 is circulated and radiated outside the housing body 11, so that heat radiation of the heat source 2 is achieved, and the speaker device 100 has a good heat radiation effect.

The diaphragm 121 vibrates in a sounding mode or a silence mode, and the heat conducted into the front acoustic cavity 101 can be circulated and radiated outside in the two modes. Therefore, the speaker box 1 can be adopted to execute heat radiation operation specifically.

Specifically, a pulse signal of a low frequency is input into the speaker box 1, and low-frequency sound made by the signal at the speaker box 1 is not heard by ears. In the application mode, the low frequency lower than 1000 Hz is input. In specifically application, the speaker box 1 is capable of independently broadcasting the pulse signal when a music play task is not executed; and when the speaker box 1 executes the music play task, the pulse signal can be also overlapped with a music signal. Since the signal is a pulse signal of an ultralow frequency, the signal is not heard by ears, and a normal hearing effect is not affected.

What is worth mentioning is that the structure form of the thermally conductive element 3 is not limited, it can be of a hollow integrally formed structure, and the thermally conductive element 3 is filled with a heat conduction medium. The heat conduction medium can be a heat conduction silicone grease with good heat conduction performance, and can be also a coolant. As a preferable application mode, the heat conduction medium can be a volatile coolant such as water; after the second end 32 absorbs the heat of the heat source 2, the heat conduction medium is gasified, the gasified heat conduction medium is conveyed to the first end 31 along with the hollow connection part 33. The first end 31 absorbs the heat of the heat conduction medium, then the heat conduction medium radiates the heat and is liquidized, the liquidized heat conduction medium flows back into the second end 32 through the connection part 33, and in a similar way, a heat radiation circulation is formed in the thermally conductive element 3.

Definitely, the thermally conductive element 3 can be also of a solid integrally formed structure, at the moment, the thermally conductive element 3 is made of a heat conduction material, such as the heat conduction silicon grease or a metal with good heat conduction performance, and the heat is directly absorbed by the second end 32 and is conducted to the first end 31 through the connection part 33.

Furthermore, the orthographic projection of the thermally conductive covering plate 13 to the diaphragm 121 along a vibration direction of the diaphragm 121 at least partially falls on the diaphragm 121. That is, because of the structure, the thermally conductive covering plate 13 is right aligned to or partially opposite to the diaphragm 121. Because of the structure, a part of the thermally conductive covering plate 13 corresponding to the diaphragm 121 is in a high-speed air flow, the air is pushed to flow under push of the diaphragm 121, then near air in the thermally conductive covering plate 13 in the front acoustic cavity 101 flows, so that the heat conducted to the front acoustic cavity 101 by the first end 31 through the thermally conductive covering plate 13 can be carried away along with the air, an effect of air cooling can be achieved through air circulation caused by vibration of the diaphragm 121, and thus the speaker device 100 has a batter heat radiation effect.

More preferably, the structure form of the first end 31 is not limited; for example, in the application mode, the first end 31 takes the shape of a rectangle; and the orthographic projection of the first end 31 to the thermally conductive covering plate 13 along the vibration direction of the diaphragm 121 completely falls on the thermally conductive covering plate 13, so that the heat radiation area between the first end 31 and the thermally conductive covering plate 13 is ensured, and heat radiation reliability can be ensured.

Furthermore, the width of the first end 31 is not limited and can be specifically set according to practical application situations. The width of the first end 31 is preferably greater than that of the connection part 33, therefore, the contact area of the first end 31 and the thermally conductive covering plate 13 can be increased. The heat radiation area is increased, and the heat radiation efficiency is effectively improved. The width of the second end 32 is not limited, either and can be set according to practical application situations, the width of the second end 32 is preferably greater than that of the connecting part 33, the contact area of the second end 32 and the heat source 2 can be increased, the heat absorption area can be increased, and the heat absorption efficiency can be effectively improved.

Furthermore, to avoid the problem that the first end 31 is dissociated in the use process, as a more preferable scheme, the thermally conductive element 3 and the thermally conductive covering plate 13 are of an integrally formed structure, so that the fixation reliability of two components is high, and the heat radiation process is reliable.

More preferably, the thermally conductive covering plate 13 is made of the metal material of good heat conduction performance, and can be, but not limited to, any one of a steel piece and a copper piece, then the thermally conductive covering plate 13 has good heat conduction performance, and the efficiency of heat conduction of the thermally conductive covering plate 13 can be ensured. Meanwhile, the thermally conductive covering plate 13 completely covers the through opening 1101 and is arranged corresponding to the diaphragm 121, so that the high-frequency acoustic performance of the front acoustic cavity 101 is effectively improved, and the acoustic performance of the speaker box 1 is optimized.

The mobile terminal 200 provided by the present application comprises a housing 4, a screen 5 which is arranged at the housing 4 in a covering manner and encircles a second accommodation space 40 together with the housing 4, and the speaker device 100 provided by the present application.

In the application mode, the speaker device 100 is mounted in the second accommodation space 30, the housing 4 is provided with a voice outlet 41 penetrating through, the voice outlet 41 communicates with the air of the sound channel 1102 to communicate the front acoustic cavity 101 with the outside, and thus a lateral heat radiation structure of the mobile terminal 200.

In the structure, under the action of vibration of the diaphragm 121, the heat radiated into the front acoustic cavity 101 from the first end 31 is circulated along with the air and radiated outside through the sound channel 1102 and the voice outlet 41 in sequence. So that the heat is prevented from accumulation in the mobile terminal 200, and the mobile terminal 200 has a good heat radiation effect.

Compared with the related art, in the speaker device of the present application, a thermally conductive element is arranged between a speaker box and a heat source, the thermally conductive element comprises a first end attached to the thermally conductive covering plate, a second attached to the heat source, and a connection part connecting the first end and the second end; the heat source conducts heat to the thermally conductive covering plate through the thermally conductive element and enters the front acoustic cavity. The diaphragm vibrates and pushes air in the front acoustic cavity to communicate with the outside through the sound channel to dissipate the heat, emitted from the first end, in the front acoustic cavity outside the housing body along with air circulation, so that heat dissipation of the heat source is achieved and the heat dissipation effect of the speaker device is good. The mobile terminal of the present application comprises a housing, a screen covering the housing and defining a second accommodation space together with the housing, and the speaker device of the present application. The speaker device is arranged in the second accommodation space. The housing is provided with a voice outlet penetrating therethrough, and the voice outlet communicates with the sound channel via the air to communicate the front acoustic cavity and the outside to dissipate the heat, emitted from the first end, in the front acoustic cavity to the outside along with the air circulation, so that accumulation of the heat in the mobile terminal is avoided and a good heat dissipation effect of the mobile terminal is effectively ensured.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker device, comprising:
a speaker box for sounding, including a housing body with a first accommodation space;
a speaker unit accommodated in the first accommodation space, including a diaphragm for partitioning the first accommodation space into a front acoustic cavity and a back cavity;
a through opening penetrating through the housing body;
a heat source spaced from the speaker box;
a thermally conductive covering plate covering the through opening, and encircling the front acoustic cavity together with the diaphragm and the housing body;
a sound channel penetrating through the housing body for communicating the front acoustic cavity with outside for forming a front cavity together with the front acoustic cavity;
a thermally conductive element connected with the speaker box and a heat source; wherein
the thermally conductive element comprises a first end fixed on one side of the thermally conductive covering plate far away from the diaphragm, a second end spaced from the first end and fixed at the heat source, and a connection part for connecting the first end and the second end.

2. The speaker device as described in claim 1, wherein the housing body comprises an upper cover and a lower cover engaging with the upper cover for forming the first accommodation space together; the through opening is arranged penetrating through the upper cover; the thermally conductive covering plate, the diaphragm and the upper cover encircle the front acoustic cavity together; the sound channel is formed in the upper cover; and the lower cover, the upper cover and the diaphragm encircle the back cavity together.

3. The speaker device as described in claim 1, wherein an orthographic projection of the thermally conductive covering plate to the diaphragm along a vibration direction of the diaphragm at least partially falls on the diaphragm.

4. The speaker device as described in claim 3, wherein an orthographic projection of the first end to the thermally conductive covering plate along the vibration direction of the diaphragm completely falls on the thermally conductive covering plate.

5. The speaker device as described in claim 4, wherein the thermally conductive element and the thermally conductive covering plate are integrally formed.

6. The speaker device as described in claim 1, wherein the thermally conductive covering plate is any one of a steel piece and a copper piece.

7. The speaker device as described in claim 1, wherein the thermally conductive element is of a hollow integrally formed structure; and the thermally conductive element is filled with a heat conduction medium.

8. The speaker device as described in claim 1, wherein the thermally conductive element is of a solid integrally formed structure; and the thermally conductive element is made of a thermally conductive material.

9. The speaker device as described in claim 1, wherein the heat source is any one of a processor and a battery.

10. A mobile terminal, comprising:
a housing;
a screen engaging with the housing for encircling a second accommodation space together with the housing;
a speaker device as described in claim 1 mounted in the second accommodation space; wherein
the housing is provided with a voice outlet penetrating through the housing; the voice outlet is in air communication with the front acoustic cavity through the sound channel so as to radiate heat conducted to the front acoustic cavity by the heat source through the thermally conductive element out of the housing.

11. A mobile terminal, comprising:
a housing;
a screen engaging with the housing for encircling a second accommodation space together with the housing;
a speaker device as described in claim 2 mounted in the second accommodation space; wherein
the housing is provided with a voice outlet penetrating through the housing; the voice outlet is in air communication with the front acoustic cavity through the sound channel so as to radiate heat conducted to the front acoustic cavity by the heat source through the thermally conductive element out of the housing.

12. A mobile terminal, comprising:
a housing;
a screen engaging with the housing for encircling a second accommodation space together with the housing;
a speaker device as described in claim 3 mounted in the second accommodation space; wherein
the housing is provided with a voice outlet penetrating through the housing; the voice outlet is in air communication with the front acoustic cavity through the sound channel so as to radiate heat conducted to the front acoustic cavity by the heat source through the thermally conductive element out of the housing.

13. A mobile terminal, comprising:
a housing;
a screen engaging with the housing for encircling a second accommodation space together with the housing;
a speaker device as described in claim 4 mounted in the second accommodation space; wherein
the housing is provided with a voice outlet penetrating through the housing; the voice outlet is in air communication with the front acoustic cavity through the sound channel so as to radiate heat conducted to the front acoustic cavity by the heat source through the thermally conductive element out of the housing.

14. A mobile terminal, comprising:
a housing;
a screen engaging with the housing for encircling a second accommodation space together with the housing;
a speaker device as described in claim 5 mounted in the second accommodation space; wherein
the housing is provided with a voice outlet penetrating through the housing; the voice outlet is in air communication with the front acoustic cavity through the sound channel so as to radiate heat conducted to the front acoustic cavity by the heat source through the thermally conductive element out of the housing.

15. A mobile terminal, comprising:
a housing;
a screen engaging with the housing for encircling a second accommodation space together with the housing;
a speaker device as described in claim 6 mounted in the second accommodation space; wherein
the housing is provided with a voice outlet penetrating through the housing; the voice outlet is in air communication with the front acoustic cavity through the sound channel so as to radiate heat conducted to the front acoustic cavity by the heat source through the thermally conductive element out of the housing.

16. A mobile terminal, comprising:
a housing;
a screen engaging with the housing for encircling a second accommodation space together with the housing;
a speaker device as described in claim 7 mounted in the second accommodation space; wherein
the housing is provided with a voice outlet penetrating through the housing; the voice outlet is in air communication with the front acoustic cavity through the sound channel so as to radiate heat conducted to the front acoustic cavity by the heat source through the thermally conductive element out of the housing.

17. A mobile terminal, comprising:
a housing;
a screen engaging with the housing for encircling a second accommodation space together with the housing;
a speaker device as described in claim 8 mounted in the second accommodation space; wherein
the housing is provided with a voice outlet penetrating through the housing; the voice outlet is in air communication with the front acoustic cavity through the sound channel so as to radiate heat conducted to the front acoustic cavity by the heat source through the thermally conductive element out of the housing.

18. A mobile terminal, comprising:
a housing;
a screen engaging with the housing for encircling a second accommodation space together with the housing;
a speaker device as described in claim 9 mounted in the second accommodation space; wherein
the housing is provided with a voice outlet penetrating through the housing; the voice outlet is in air communication with the front acoustic cavity through the sound channel so as to radiate heat conducted to the front acoustic cavity by the heat source through the thermally conductive element out of the housing.
